(19) United States
(12) Patent Application Publication
(10) Pub. No.: US 2010/0258521 A1
(43) Pub. Date: Oct. 14, 2010

(54) CLOSING CAP FOR A CONTAINER, METHOD FOR CLOSING A CONTAINER AND METHOD FOR MANUFACTURING A CLOSING CAP FOR A CONTAINER

(76) Inventor: Antonio Bertolaso, Cologna Veneta (IT)

Correspondence Address: BROWDY AND NEIMARK, P.L.L.C.;624 NINTH STREET, NW, SUITE 300, WASHINGTON, DC, 20001-5303, US

(21) Appl. No.: 12/670,166

(22) PCT Filed: Jul. 23, 2008
(86) PCT No.: PCT/IB08/01920

§ 371 Date: Jun. 23, 2010

(30) Foreign Application Priority Data
Jul. 25, 2007 (EP) 07425476.7
Sep. 5, 2007 (IT) PD2007A000286

(51) Int. Cl. B65D 41/34; B67B 1/00; B23P 19/04

(52) U.S. Cl. 215/253; 215/316; 53/484; 29/428

(57) ABSTRACT

Closing cap for a container comprising a covering (9) made of metallic material with a substantially cylindrical shape, having a side wall (13) divided by an annular weakening line (44) into two portions. A plastic insert (15) is fixed by means of gluing or mechanical retaining means to the inner surface (10) of the covering (9). The cap also comprises an anti-tamper seal (20) which is fixed in a middle position (210) of the inner surface (10) of the covering (9) and consists of a plastic ring.

### FIELD OF APPLICATION

The present invention concerns a closing cap for a container, method for closing a container and method for manufacturing a closing cap for a container according to the preamble of the corresponding independent claims.

The cap in question is intended to be used advantageously in the industry for bottling beverages such as wine, whisky, mineral water, juices or the like, in order to seal the mouth of the containers generally consisting of glass or plastic bottles.

In greater detail, the cap according to the present invention is of the screw type with a safety seal for indicating initial opening and therefore ensuring that the bottle is protected against possible tampering.

### BACKGROUND ART

The industrial bottling plants which nowadays are conventionally available on the market perform in sequence the various operations of rinsing, filling and capping. This last operation is intended to perform automatic closing of the containers using capping or capsuling machines which are generally of the rotating carousel type. Numerous equidistant capping heads are mounted peripherally above the carousel in a peripheral position and perform closure of the containers during their travel around the carousel.

Different capping machines are known, each being equipped with specific mechanical solutions designed depending on the cap which is to be fitted and the container to be closed.

A first type of capping machine, or so-called rolling machine, envisages the use of capping heads provided with rollers which are positioned rotationally against a metallic covering flange of the cap positioned on the neck of the bottle. The rollers act so as to push the flange against the threaded finishing part of the bottle neck, deforming it by means of rolling and impressing onto it a thread which is shaped so as to match the thread of the bottle as is for example described and illustrated in the U.S. Pat. No. 4,086,747 and U.S. Pat. No. 3,303,955.

This solution has the drawback that it produces caps which are aesthetically not very attractive since the covering, instead of forming a smooth surface on which writing or drawings may be printed, has an undulating form owing to the presence of the thread.

A second type of capping machine, or a so-called “capsuling” machine, performs screwing of the screw caps onto the threaded top of the bottles.

The patents EP 248,145 and DE 3912324 describe two examples of capsuling machines with gripping means associated with each head so as to screw the caps (or capsules) onto the containers rotating about the axis of the head.

For this purpose, the caps are usually made with a metal covering made of tin or aluminium provided on the bottom with a seal able to press against the mouth of the bottle, and a pre-threaded insert usually made of plastic and fixed either mechanically or by means of gluing to the external metal covering.

In connection with this latter technique and in accordance with a cap design which is particularly widespread on the market, known by the tradename STELVIN LUX®, the external aluminium covering is deformed by means of rolling once it has been applied onto the neck of the bottle underneath the annular rib (collar) projecting at a predetermined distance from the bottle mouth.

Weakening incisions are formed on the external covering above the collar and arranged circumferentially so that, upon opening by means of unscrewing of the cap, the covering part situated below the collar, or skirt, is separated from the top part of the cap along the weakening circumference.

According to an important characteristic feature of these caps, the skirt of the covering extends until it adheres against the neck of the bottle. Over the entire covering, which is substantially smooth, with the sole exception of the fold of the covering which is formed by means of rolling underneath the collar, it is possible to print images or writing as required. The absence of the thread impression on the external surface of the covering, in addition to offering an improved printing area, is particularly in demand on the market since the result is that these screw caps resemble stoppers of the more conventional type made of cork with an external metal covering.

These screw caps are commonly mounted on bottles by means of a suitable capping machine which is described for example in the patent WO 2007/054985 which performs in sequence: screwing of the cap and compression thereof onto the mouth of the bottle by means of a rotating pressing member situated in the central part of the capping head; and then rolling of the covering by means of two pairs of rollers able to deform the covering below the collar of the bottle so as to engage mechanically the said covering with the bottle. In this way, upon opening the cap, the skirt of the covering remains attached to the bottle, while the top part is separated from the bottom part along the weakening line following unscrewing of the insert.

The international patent WO0063089 describes another type of closing cap which comprises a metal covering positioned so as to cover a plastic insert provided with an internal threading for screwing to the neck of a bottle.

The connection between the covering and the insert is performed either mechanically or by means of gluing.

An annular anti-tamper seal is provided, engaging with an interlocking fit during insertion of the cap onto the bottle neck underneath its collar, and is connected to the plastic insert by means of first bridge-pieces.

The metal covering does not extend until it adheres against the neck of the bottle, but only along a bottom section which terminates in a lug folded underneath the plastic annular seal, and is connected to the remaining top part of the covering by means of second bridge-pieces.

When the cap is unscrewed for the first time in order to open the container, breakage of the first and second bridge-pieces occurs.

The bottom section of the covering is not extracted during opening since it is attached to the annular seal by means of the lug folded underneath it. However, this bottom section, once freed from the bond to the top part of the covering by means of breakage of the second bridge-pieces, is free to fall axially until it encounters the widened portion of the bottle.

This solution has certain drawbacks. Firstly, once the cap has been opened, the part which remains on the bottle neck, composed of the bottom section of the covering and the safety ring, remains loose and does not allow an easy grip, being aesthetically unattractive; secondly, the absence of a skirt in the covering which extends as far as a contact point with the bottle favours the entry of dust and allows the bottom part to rotate about the bottle neck; thirdly, the need to fold by means of a rolling operation the end lug of the covering underneath the safety ring constitutes an additional step which requires the use of a more costly capping machine; furthermore the absence of the skirt reduces the surface area for writing or symbols; and finally exposure of the anti-tamper seal is aesthetically unattractive.

There also exists a widespread need on the market to seal the containers using caps which simulate externally conventional closures with cork stoppers and a metallic—aluminium or tin—covering. These caps require breakage of the breakage of the covering upon initial opening by way of proof that the closure has not been tampered with.

Furthermore, the metal covering must be firmly secured and adhere to the bottle at the end part of the skirt so as to prevent, upon opening of the cap, the covering from moving and no longer allowing a secure grip of the bottle.

For this purpose, the skirt of the covering must advantageously extend downwards until it comes into contact at a predetermined distance from the bottle neck, this distance depending on the form of the said bottle.

Consequently, it is well-known to use caps, the covering of which has a length which may be chosen typically from 50 mm, 60 mm and 70 mm, depending on the form of the bottle, so as to ensure that the skirt at the bottom always comes into contact with and adheres against the widened part of the bottle so as to be attached firmly to the latter even after opening of the cap.

At present, in the case in particular of capsuling machine heads, it is possible to adjust the twisting force with which the cap is screwed onto the bottle, varying the distance between suitable magnetic mating means or by operating suitable friction means as is, for example, described in the patents WO 00/02810, U.S. Pat. No. 5,490,369 and WO 96/07611.

### DISCLOSURE OF THE INVENTION

In this situation the problem underlying the present invention is to overcome the drawbacks of the prior art mentioned above, by providing a closing cap for containers, in particulars bottles or the like, which has a smooth and large surface for displaying writing or illustrations.

Another object of the present invention is to provide a closing cap which is simple to close and does not require special machines or rolling operations.

Another object of the present invention is to provide a screw-type closing cap which resembles externally a cork stopper with metal covering.

Another object of the present invention is to provide a closing cap with an anti-tamper seal which is entirely reliable.

These objects, together with others, are all achieved by the closing cap according to the invention, which comprises a covering made of metallic material with a substantially cylindrical shape, having an inner surface and an outer surface, formed by a bottom wall and by a side wall divided by an annular weakening line into two portions, i.e. a top portion with a smooth outer face, connected continuously to the bottom wall, and a bottom portion, provided with an open end edge extending until it rests against and adheres to the side wall of the container and in particular to the side wall of the neck of the container;
a plastic insert fixed by means of gluing to the inner surface of the covering along the bottom wall and provided with a side wall having internally shaped an inner thread intended to be screwed onto the outer thread of the container.

According to the invention the abovementioned cap is characterized in that it comprises an anti-tamper seal which is fixed to the inner surface of the bottom portion of the covering in a middle position of the covering so that it is arranged underneath the collar of the container, the seal consisting of a plastic ring provided with at least one flange able to engage elastically in a retaining relationship underneath the collar of the container.

Owing to this invention it is possible to seal easily containers while maintaining the technical and aesthetic features of the caps required today by the market with a cork stopper, metal covering and anti-tamper seal, by means of a novel cap with a screw-type closure.

Another object of the present invention is to provide a capping method which does not require costly rolling operations or special machines.

This object, together with others, are all achieved by the closing method according to the present invention having the characteristic features described in Claim 6.

Another object of the present invention is to provide a method for manufacturing a closing cap which is simple and economical to implement.

This object together with others are all achieved by the method for manufacturing closing caps according to the present invention having the characteristic features described in Claim 9.

### BRIEF DESCRIPTION OF THE DRAWINGS

The technical features of the invention, in accordance with the abovementioned objects, may be clearly determined from the contents of the claims indicated below and the advantages thereof will emerge more clearly from the detailed description which follows, provided with reference to the accompanying drawings which show a purely exemplary and non-limiting embodiment thereof in which:

FIG. 1 shows a first embodiment of the closing cap according to the invention mounted on the neck of a bottle, in a cross-sectional view along a diametral plane of the cap;

FIG. 2 shows a second embodiment of the closing cap according to the invention mounted on the neck of a bottle, in a cross-section along a diametral plane of the cap;

FIGS. 3 and 4 show enlarged details of the caps according to FIGS. 1 and 2;

FIG. 5 shows a further embodiment of the closing cap according to the invention mounted on the neck of a bottle, in a cross-sectional view along a diametral plane of the cap, with an anti-tamper seal fixed by means gluing;

FIG. 6 shows a further embodiment of the closing cap according to the invention mounted on the neck of a bottle, in a cross-sectional view along a diametral plane of the cap, with an anti-tamper seal fixed by means of a mechanical joint.

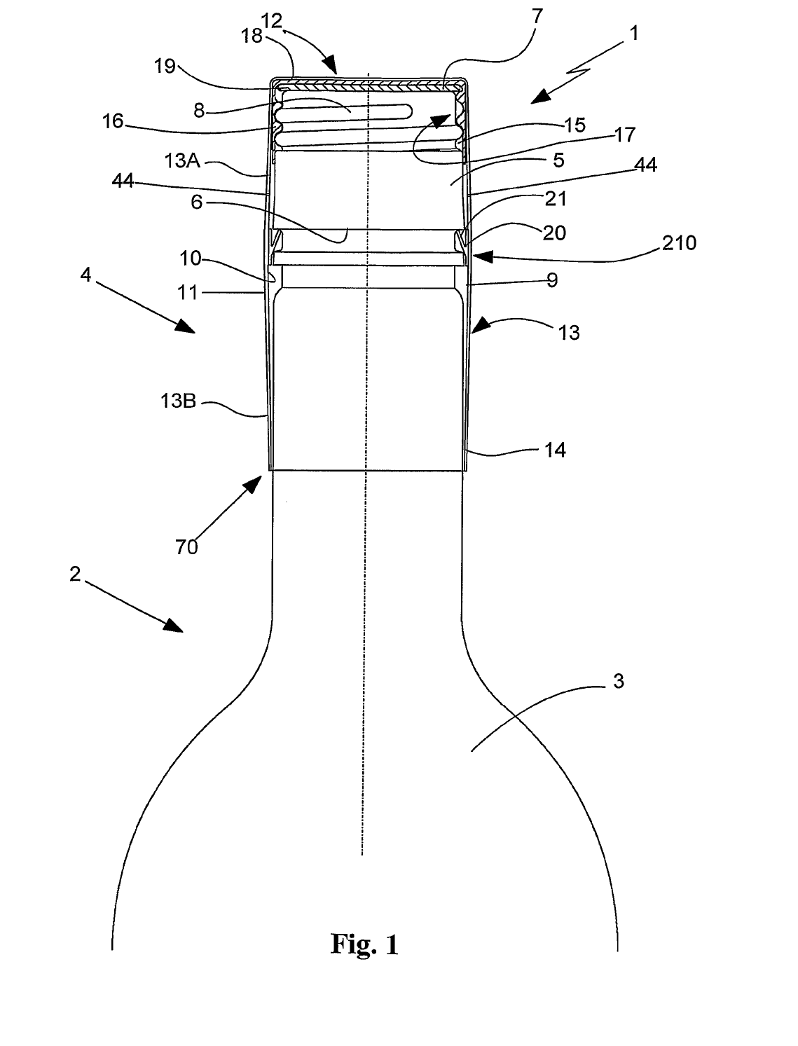

### DETAILED DESCRIPTION OF A PREFERRED EXAMPLE OF EMBODIMENT

With reference to the accompanying drawings 1 denotes overall the closing cap according to the present invention.

This cap 1 is of the so-called screw type or type intended to be screwed onto the screwed onto the threaded head of a container 2.

In greater detail, the container 2 preferably consists of a glass bottle provided in an entirely conventional manner with a side wall 3 which tapers at the top so as to define an elongated neck 4 with, formed therein, an annular collar 5 projecting radially and defining at least one bottom shoulder 6.

An external thread 8 generally formed by a rib wound spirally 2-4 times is formed above the collar 5 in the vicinity of the mouth 7.

The bottle 2 is preferably of the standard type which can be found on the market and is intended for containing alimentary products and in particular wine.

Obviously, in place of a glass bottle, it is nevertheless possible to use a plastic bottle having the characteristic features indicated above with reference to a glass bottle, without thereby departing from the scope of protection of the present patent.

The cap 1 comprises a covering 9 made of metallic material, for example tin or aluminium, with a substantially cylindrical form, having an inner surface 10 and an outer surface 11 and formed by a bottom wall 12 and by a side wall 13.

The latter is divided by an annular weakening line into two portions, i.e. a top portion 13A with a smooth outer surface 11A, connected continuously to the bottom wall 12, and a bottom portion 13B provided with an open end edge 14 extending until it rests against, at 70, and adheres to the outer wall of the bottle 2. In greater detail, the abovementioned contact point 70 is provided, depending on the bottle, at about 50-70 mm from the mouth 7 and therefore also on the neck 4 of the bottle 2, as clearly indicated in the figures.

The cap 1 also comprises an insert 15 which is made of plastic and fixed to the inner surface of the covering 9 along the bottom wall 12 by means of retaining means described in detail in the following, and is provided with a side wall 16 having internally shaped an inner thread 17 intended to be screwed onto the outer thread 8 of the bottle 2.

In greater detail, the insert 15 is in the form of an overturned cup with the base 18 formed as one piece with the side wall 16 and fixed with a layer of glue to the bottom 12 of the covering 9.

The inner part of the base 18 of the insert 15 is provided with a seal 19 which is intended to seal the cap on the mouth 7 of the bottle 2. This seal 19 is retained inside the cap when the latter is separated from the bottle 2, on the base 18, by the same inner thread 17 which projects from the side wall 16.

According to the idea forming the basis of the present invention, an anti-tamper seal 20 is provided, said seal being fixed to the inner surface of the bottom portion 13B of the covering 9 in a middle position 210 of the covering 9 itself, so as to be arranged underneath the collar 5 of the bottle 2.

In greater detail, the seal 20 is formed by a ring of plastic material with a flange 21 able to engage elastically in a retaining relationship underneath the collar 5 of the bottle.

More clearly, as will be described more fully below, during insertion of the cap 1 onto the top of the bottle 2, the flange 21, after passing over the collar 5, widens engaging, without the possibility of return, underneath the shoulder 6 of the collar 5. In this way, the bottom part of the cap consisting of the safety ring 20 and the bottom portion 13B of the covering 9 fixed thereto remains rigidly attached to the bottle 2.

It is important, to prevent any displacement of the abovementioned bottom part of the cap 1, that the end edge 14 of the bottom portion 13B of the covering should rest so as to engage with and adhere to the neck of the bottle 2 when the flange 21 is arranged underneath the collar 5 so as to fix in position correctly this bottom part of the cap 1 between two substantially end positions.

According to a preferred embodiment of the present invention, the retaining means are obtained by at least a layer of glue 90 placed between the plastic insert (15) and said covering (9) and preferabily along the bottom wall 12.

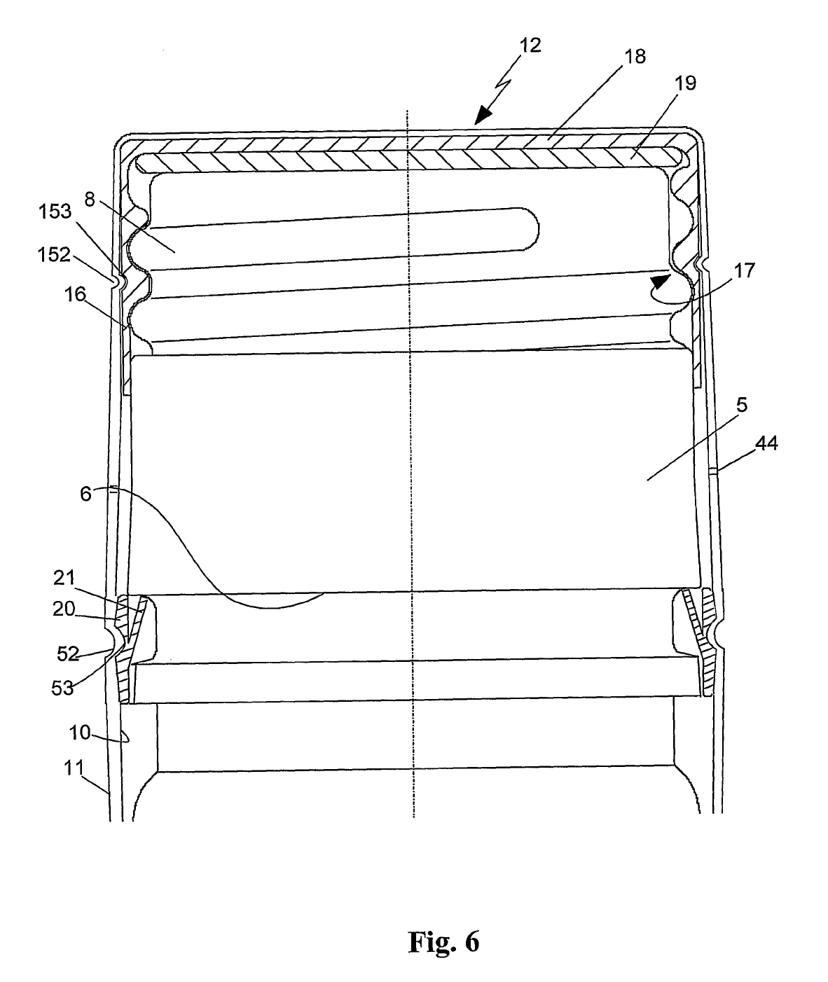

Alternatively, the retyaining means are obtained by means a first mechanical joint of the male/female type placed between a first shaped portion 152 of the covering 9 formed in correspondence of a top portion 13A of the side wall 13, and a correspondingly shaped portion 153 of the plastic insert 15, as represented in FIG. 6.

According to this embodiment, the first shaped portion 152 is in the form of a first rib obtained on the inner surface 10 of the covering 9 by means of roll forming realized on the external surface of the covering. Said rib is inserted in a retaining relationship into a corresponding groove 153 substantially obtained on the plastic insert 15 (for instance during the moulding of the plastic insert).

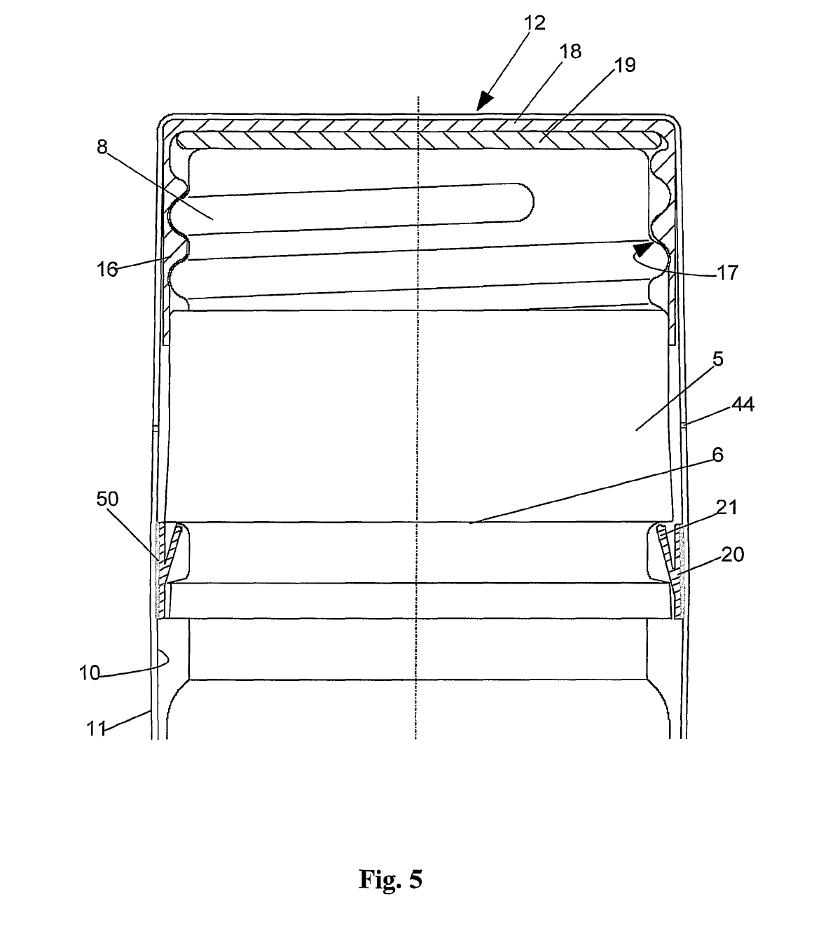

In accordance with a preferred cap design according to the present invention, the anti-tamper seal 20 is fixed to the inner surface 10 of the bottom portion 13B of the covering 9 in the middle position 21 by means gluing (as, for example, shown in FIG. 5 where the layer of glue has been indicated by 50).

In this way it is possible to keep the outer surface 11 of the covering 9 completely smooth both in the upper portion 13A and in the bottom portion 13B. As a result of this feature it is possible to have a large area for the application of writing, symbols or figures.

Alternatively, the anti-tamper seal 20 may be fixed to the inner surface 10 of the bottom portion 13B of the covering 9 by means of a second mechanical joint of the male/female type.

For this purpose, the covering 9 during production of the cap (and not during the capping operation) will be made with a second shaped portion formed in the middle position 210 with which a correspondingly shaped portion of the seal 20 will be mechanically associated.

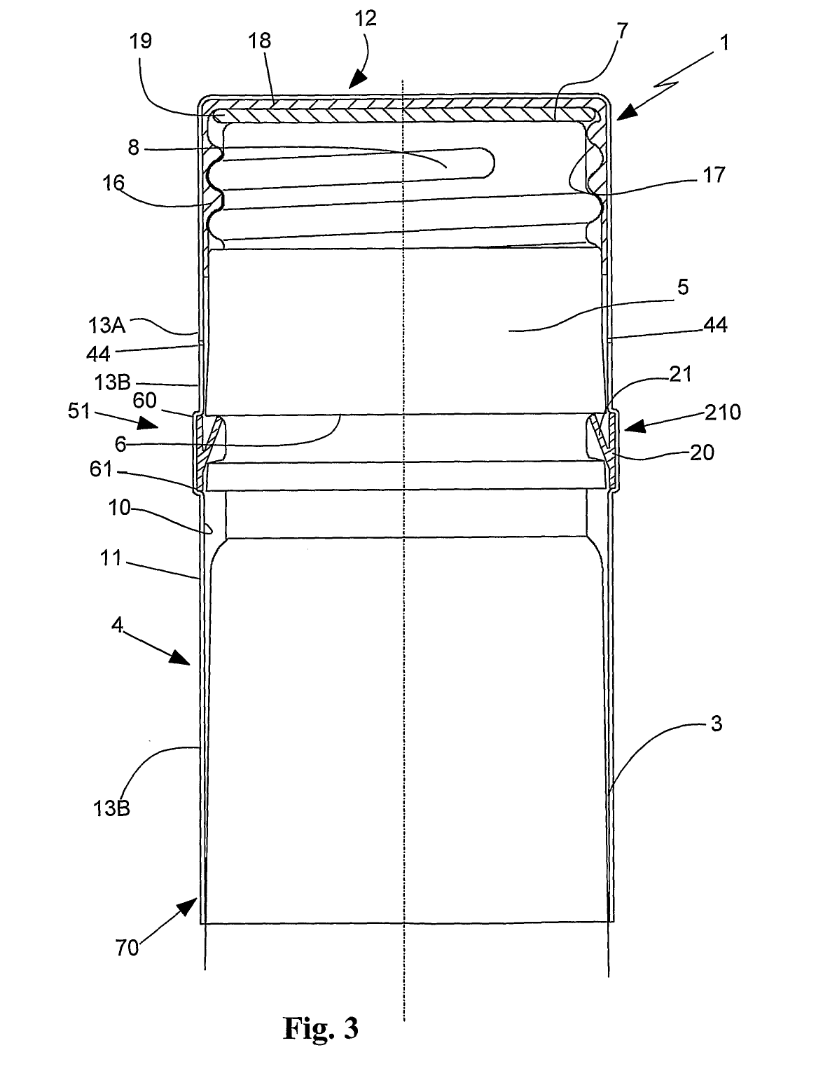

Two possible designs for mechanical joining together of the covering 9 and the seal 20 are shown in the examples according to FIGS. 3 and 6, where, in FIG. 3, the seal 20 is retained in a seat 51 projecting externally from the covering and formed with a stepped ring, while, in FIG. 6, the covering has a second rib which is inserted inside a correspondingly shaped recess 53 formed in the safety seal 20. Obviously, mechanical fixing together of seal 20 and the covering 9 may be performed using various other forms of male/female joints, also achieved using separate and non-continuous portions along the circumference of the cap 1.

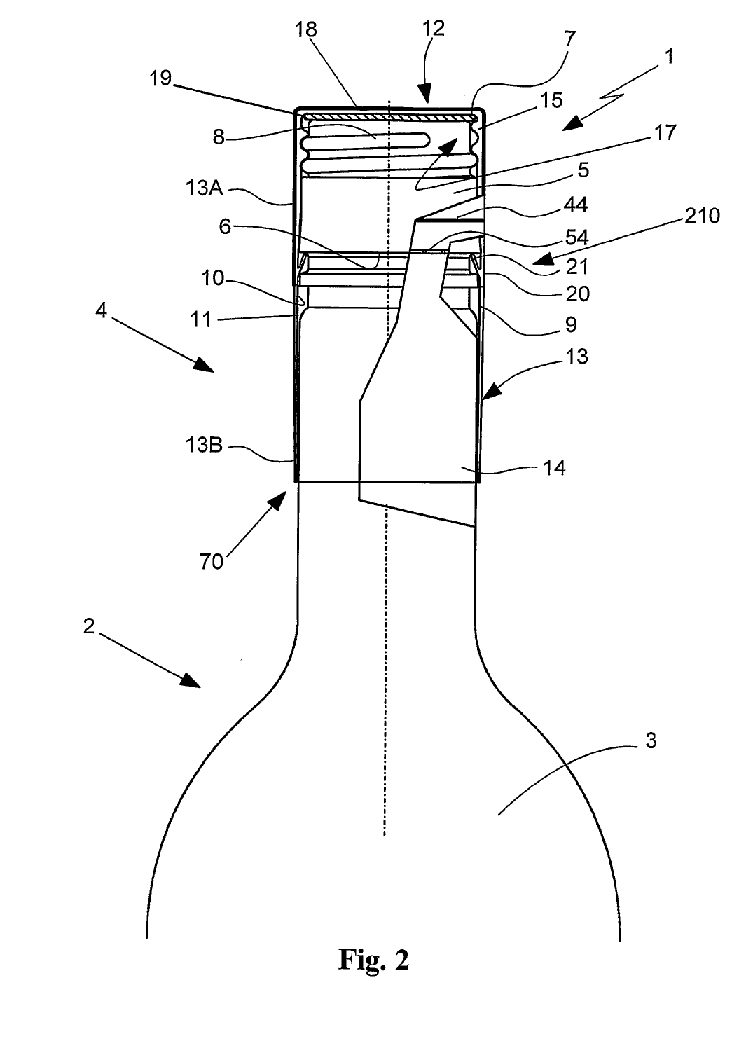

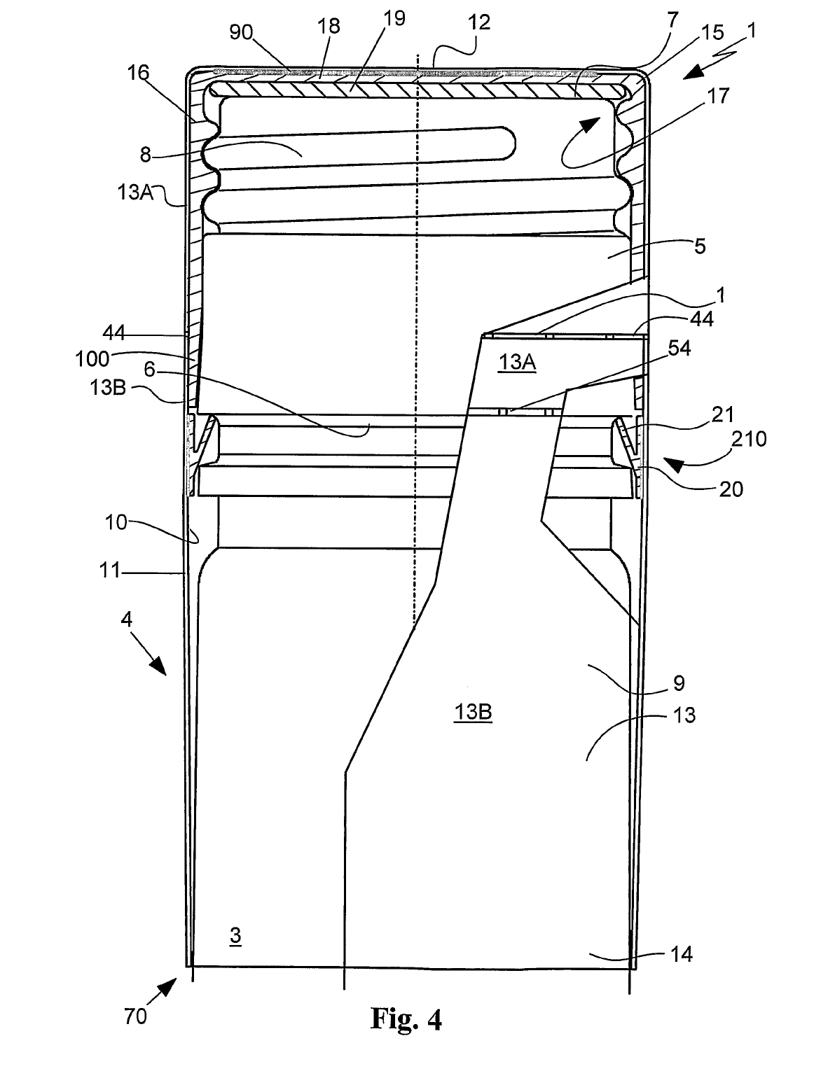

Preferably, the anti-tamper seal 20 is obtained by means of a single moulding as one piece with the insert 15, as shown in FIGS. 2 and 4. Connection bridge-pieces able to define a second weakening line 54 are envisaged for joining together the two parts. The bridge-pieces may be obtained from a continuous wall by means of incisions or directly during moulding.

The present invention also concerns a method for capping a container 2 which is entirely similar to that described above, preferably using the cap 1 described above, to which reference will therefore be made in the remainder of the description. The capping operations described below are suitable for being performed automatically by a capsuling machine which is well-known to a person skilled in the art and provided with a rotating carousel having a plurality of capping heads mounted peripherally.

The capping machine is provided with guide means for removing upstream the containers directly from the support plates for example of a filling machine or from a recessed wheel and for releasing them downstream, once they have been sealed during the travel on the carousel, to a screw feeder or to a conveyor belt in order to convey them out of the plant.

The capping heads, in addition to rotating about the axis of the machine, also rotate about their central axis by means of a spindle and are provided with actuator means (not shown in detail in that they are well-known to the person skilled in the art) for screwing the caps onto the top of the containers.

Such a machine of the known type performs compression of the caps onto the top of the bottles 2 and rotation thereof so as to screw them on by means of a pressing member pushed by a spring against the bottom wall 12 of the cap 1 by means of a magnetic friction system so that screwing is performed with the correct twisting force on the bottle 2.

The abovementioned method envisages an operation for fitting the cap 1 onto the top of the bottle starting from the open end edge 14 of the covering 9.

This operation may be performed, for example, using the known “pick and place” gripping or pulling techniques.

At this point, compression and screwing of the caps 1 is performed, for example, by means of a capping head of a conventional capping machine acting externally on the covering of the cap and advantageously on the bottom 12 thereof.

During the final stage of the above-mentioned screwing operation, the following occurs:
engagement of the anti-tamper seal 20 underneath the collar 5 of the bottle 2;
resting of the end edge 14 of the bottom portion 13B of the covering 9 so as to adhere to the side wall 3 of the neck 4 of the bottle 2;
contact of the mouth 7 of the bottle 2 against the seal 19 positioned on the base 18 of the insert 15.

According to the present invention, since the safety seal 20 is fixed to the covering 9 during manufacture of the cap 1, during the entire capping process the covering remains intact and undeformed, there not being envisaged any operation involving rolling on its outer surface 11.

The present invention also relates to a method for manufacturing a cap 1 intended to close a container 2 which is advantageously described hereinbelow with reference to the cap 1 considered above.

The method envisages initially, in a manner which is conventional per se and well-known to a person skilled in the art, forming the outer covering 9 of the cap 1 by means of the arrangement of metal—tin or aluminium—sheet on a die and then shaping it into the desired cylindrical form by means of successive punching operations.

The length to which the side wall 13 of the covering is pulled depends on the container 2 which must be capped since the end edge 14 must manage to rest against, at 70, and adhere to the side wall 3 of the neck 4 of the container 2.

The method then envisages a first fixing operation by means of which the plastic insert 20 is glued to the inner surface 10 of the covering 9 along the bottom wall 12.

Preferably, a layer of glue 90 is inserted between the bottom wall 12 of the covering 9 and the base 18 of the insert 15.

Alternatively, the first fixing step is performed by making a first shaped portion 152 on the top portion 13A of said covering 9 and by joining mechanically said first shaped portion 152 to a correspondingly shaped portion 153 of said insert 15.

A second fixing operation is then performed, by means of which the anti-tamper seal 20 is also fixed to the inner surface 10 of the covering 9 in the middle position 210 of the latter so that it is arranged underneath the collar 5 of the container 2 and more precisely with the flange 21 engaging underneath the shoulder 6 of the collar 5, as explained above.

At this point, an operation is performed for forming an annular weakening line 44 on the covering 9 above the seal 20 by cutting aligned incisions along a circumference. This weakening line 44 divides the wall of the covering 9 into two portions, i.e. upper portion 13A with smooth outer face, connected continuously to the bottom wall 12, and having the insert 15 mounted fixed thereon, and a bottom portion 13B with the anti-tamper seal 20 mounted fixed thereon.

The second operation of fixing the seal 20 to the covering 9 may advantageously be performed by means of gluing onto the inner surface 10 of the covering 11. In this way it will be possible to obtain a covering 9 with a completely smooth surface.

Alternatively, the second fixing operation may be achieved by providing a second shaped zone (51, 52) on the bottom portion (13B) of the covering (9) and combining it mechanically with a substantially correspondingly shaped portion (53) of the anti-tamper seal (20) by means of a joint of the male/female type.

For this purpose, a first step 60 may be formed in accordance with the example of FIG. 3 by means of a first fold with plastic deformation of the covering 9; then the seal 20 may be inserted in the covering 9 until its rests on this first step 60 and then a second step 61 may be formed by means of a second fold with plastic deformation of the covering 9 so as to close the seal 20 in a seat.

In accordance with FIGS. 4 and 3, the insert 15 and the seal 20 may be formed both as one piece and separate from each other. In the first case the side wall 16 of the insert will extend with a connecting portion 100 as far as the anti-tamper seal 20. In this case, the first and the second fixing operation therefore require insertion together, inside the covering 9, of both the insert 15 and the seal 20 after the arrangement of layers of glue on at least one of the surfaces intended to come into contact together so as to define two separate joining points, namely between the seal 20 and the covering 9 and between the insert 15 and the covering 9.

The operation of forming the weakening line 44 may advantageously be performed after assembling together all the components of the cap 1.

When the insert 15 and the seal 20 are formed as one piece, the incisions may have a depth sufficient to create a weakening line both on the covering 9 and on the portion 100 connecting together insert 15 and seal 20. In this case the two weakening lines 44, 54 will be arranged above each other.

Alternatively, the insert and the seal may also be formed as one piece, but with the incisions between seal and insert 15 already provided during moulding and preferably able to define (as shown in FIG. 4) a weakening line 54 which is slightly lower than that 44 provided on the covering 9 (see FIG. 4) so as to keep the anti-tamper seal 20 covered by the covering 9 also after opening of the cap 1 for the first time.

Functionally speaking, upon opening the cap 1 for the first time, the threaded insert 15 is raised from the mouth 7 of the container 2, carrying with it the top portion 13A of the covering 9 which is fixed thereto and which is separated along the weakening line 44, tearing the connecting bridge-pieces from the bottom portion 13B which remains instead attached to the bottle 2 by means of the anti-tamper ring 20 to which it is fixed and which is in turn retained on the bottle 2 by means of the flange 21 engaged underneath the shoulder 6 of the collar 5.

The invention thus conceived therefore achieves the predefined objects.

Obviously it may assume, in its practical embodiment also forms and configurations which are different from that illustrated above, without thereby departing from the present scope of protection.

Moreover, all the details may be replaced by technically equivalent parts, and the dimensions, forms and materials used may be of any nature according to requirements.

1. Closing cap for a container of the type provided with a side wall (3) which tapers at the top so as to define an elongated neck (4) with, formed therein, an annular collar (5) projecting radially and defining at least one bottom shoulder (6) and an outer thread (8) provided above said collar (5), which cap comprises:
a covering (9) made of metallic material with a substantially cylindrical shape, having an inner surface (10) and an outer surface (11), formed by a bottom wall (12) and by a side wall (13) divided by an annular weakening line (44) into two portions, i.e. a top portion (13A) with a smooth outer face, connected continuously to said bottom wall (12), and a bottom portion (13B), provided with an open end edge (14) extending until it rests against and adheres to a side wall (3) of said container and in particular to the side wall of the neck (4) of said container (2);
a plastic insert (15) fixed by means of retaining means (90, 152, 153) to the inner surface (10) of said covering (9) and provided with a side wall (16) having internally shaped an inner thread (17) intended to be screwed onto the outer thread (8) of said container (2);
characterized in that it comprises an anti-tamper seal (20) which is fixed to the inner surface (10) of the bottom portion (13B) of said covering (9) in a middle position (210) of the covering (9) so that it is arranged underneath the collar (5) of said container (2), said seal (20) consisting of a plastic ring provided with at least one flange (21) able to engage elastically in a retaining relationship underneath the shoulder (6) of the collar (5) of said container (2).

2. Closing cap according to claim 1, characterized in that said retaining means (90, 152, 153) are obtained by at least a layer of glue (90) placed between the plastic insert (15) and said covering (9).

3. Closing cap according to claim 1, characterized in that said retaining means (90, 152, 153) are obtained by means a first mechanical joint of the male/female type placed between a first shaped portion (152) of said covering (9) formed in correspondence of a top portion (13A) of said side wall (13), and a correspondingly shaped portion (153) of said insert (15).

4. Closing cap according to claim 1, characterized in that said anti-tamper seal (20) is fixed to the inner surface (10) of the bottom portion (13B) of said covering (9) in said middle position (210) by means of gluing and characterized in that said bottom portion (13B) of the covering (9) has a smooth outer face.

5. Closing cap according to claim 1, characterized in that said anti-tamper seal (20) is fixed to the inner surface (10) of the bottom portion (13B) of said covering by means of a second male/female mechanical joint between said seal (20) and a second shaped portion (51, 52) of said covering (9) formed in said middle position (210).

6. Closing cap according to claim 1, characterized in that said anti-tamper seal (20) is joined to said insert (15) by means of connection bridge-pieces able to define a second weakening line (54).

7. Closing cap according to claim 1, characterized in that said insert (15) is provided with a base (18) formed as one piece with said side wall (16), fixed externally by means of gluing to the bottom wall (12) of said covering (9) and having internally associated a seal (19).

8. Method for capping a container of the type provided with a side wall (3) which tapers at the top so as to define an elongated neck (4) with, formed therein, an annular collar (5) projecting radially and defining at least one bottom shoulder (6), and an outer thread (8) provided above said collar (5), using a cap (1) comprising:
a covering (9) made of metallic material with a substantially cylindrical shape, having an inner surface (10) and an outer surface (11), formed by a bottom wall (12) and by a side wall (13) divided by an annular weakening line (44) into two portions, i.e. a top portion (13A) with a smooth outer face, connected continuously to said bottom wall (12), and a bottom portion (13B), provided with an open end edge (14) extending until it rests against (70) and adheres to a side wall (3) of said container and in particular to the side wall of the neck (4) of said container (2);
a plastic insert (15) fixed by means of retaining means to the inner surface (10) of said covering (9) and provided with a side wall (16) having internally shaped an inner thread (17) intended to be screwed onto the outer thread (8) of said container (2);
an anti-tamper seal (20) which is fixed to the inner surface (10) of the bottom portion (13B) of said covering (9) in a middle position (210) of the covering (9) so as to be arranged underneath the collar (5) of said container (2), said seal (20) consisting of a plastic ring provided with at least one flange (21) able to engage elastically in a retaining relationship underneath the shoulder (6) of the collar (5) of said container (2),
which method comprises the following operating steps:
fitting the cap (1) onto the top of the container (2) by means of insertion of the open end edge (14) of the covering (9) onto the mouth (7) of said container (2);
compression and screwing by means of a capsuling head acting externally on the covering (9) of said cap (1);
engagement of said anti-tamper seal (20) underneath the collar (5) of said container (2) at the end of said compression step;
adhering contact (70) of the end edge 14 (14) of the bottom part (13B) of said covering (9) against the side wall (3) of the container (2) at the end of said compression step;

9. Capping method according to claim 8, characterized in that, at the end of said compression and screwing step, the mouth (7) of said container (2) makes sealing contact against a seal (19) associated internally with the bottom wall (12) of said insert (15).

10. Capping method according to claim 8, characterized in that said covering (9) remains intact and undeformed during all the steps of said capping method, in particular there not being envisaged any rolling operation acting on its outer surface (11).

11. Method for manufacturing a cap intended to close a container of the type provided with a side wall (3) which tapers at the top so as to define an elongated neck (4) with, formed therein, an annular collar (5) projecting radially and defining at least one bottom shoulder (6), and an outer thread (8) provided above said collar (5), which method comprises the following operating steps:
arranging a metal sheet on a die;
shaping said sheet, by means of successive punching operations, into a covering (9) with a substantially cylindrical shape, formed by a bottom wall (12) connected continuously to a side wall (13);
a first fixing step by means of which a plastic insert (15) is fixed to the inner surface (10) of said covering (9), said insert (15) being provided with a side wall (16) having internally shaped an inner thread (17) intended to be screwed onto the outer thread (8) of said container (2);
a second fixing step by means of which an anti-tamper seal (20) is fixed to the inner surface (10) of said covering (9) in a middle position (210) so that it is arranged underneath the collar (5) of said container (2), said seal (20) consisting of a plastic ring provided with at least one flange (21) able to engage elastically in a retaining relationship underneath the shoulder (6) collar (5) of said container (2);
forming an annular weakening line (44) situated above said seal (20) by cutting aligned incisions in said covering (9), so as to divide it into two portions, i.e. an upper portion (13A) with smooth outer face, connected continuously to said bottom wall (12), and having the insert (15) mounted fixed thereon, and a bottom portion (13B) with said anti-tamper seal (20) mounted fixed thereon.

12. Method according to claim 11, characterized in that said second fixing step is performed by means of gluing.

13. Method according to claim 11, characterized in that said second fixing step is performed by providing a shaped zone (51, 52) on the bottom portion (13B) of said covering (9) and joining it mechanically with a substantially correspondingly shaped portion (53) of said anti-tamper seal (20).

14. Method according to claim 11, characterized in that said first and second fixing steps are performed by inserting inside said covering (9) said insert (15) and said anti-tamper seal (20) which are fixed together as one piece.

15. Method according to claim 14, characterized in that said operation of forming said annular weakening line (44) is performed by means of incisions which are formed both in said covering (9) and in a portion (100) connecting together said insert (15) and said anti-tamper seal (20).

16. Method according to claim 14, characterized in that said first fixing step is performed by making a first shaped portion (152) on a top portion (13A) of said covering (9) and by joining mechanically said first shaped portion (152) to a correspondingly shaped portion (153) of said insert (15).
